(19) United States
(12) Patent Application Publication
(10) Pub. No.: US 2026/0197576 A1
(43) Pub. Date: Jul. 9, 2026

(54) SPEAKER AND HEADSET

(71) Applicant: Honor Device Co., Ltd., Shenzhen (CN)

(72) Inventors: Yunhai LI, Shenzhen (CN); Yonghua ZHANG, Shenzhen (CN)

(73) Assignee: Honor Device Co., Ltd., Shenzhen (CN)

(21) Appl. No.: 19/129,507

(22) PCT Filed: Nov. 9, 2023
(86) PCT No.: PCT/CN2023/130752

§ 371 Date: May 13, 2025

(30) Foreign Application Priority Data
Apr. 18, 2023 (CN) 202310421851.2

(51) Int. Cl. H04R 1/10; H04R 7/02; H04R 9/02

(52) U.S. Cl. CPC H04R 1/1058; H04R 1/1016; H04R 7/02; H04R 9/025

(57) ABSTRACT

This application discloses a speaker and a headset, and belongs to the field of audio technologies. The headset includes a speaker, and the speaker includes a first magnetic body, a second magnetic body, a basket, a first voice coil, a first diaphragm, a second voice coil, and a second diaphragm. The first magnetic body is disposed around an outer circumference of the second magnetic body. The basket includes a peripheral part and a basket top connected to the peripheral part. The peripheral part is disposed around an outer circumference of the first magnetic body. The first voice coil is connected to the first diaphragm. The first magnetic body and the basket top are combined to form a magnetic loop with the second magnetic body. This application helps reduce a volume of the headset, and facilitates miniaturization of the headset.

### CROSS-REFERENCE TO RELATED APPLICATIONS

This application is a national stage of International Application No. PCT/CN2023/130752, filed on Nov. 9, 2023, which claims priority to Chinese Patent Application No. 202310421851.2, filed on Apr. 18, 2023. The disclosures of both of the aforementioned applications are hereby incorporated by reference in their entireties.

### TECHNICAL FIELD

This application relates to the field of audio technologies, and in particular, to a speaker and a headset.

### BACKGROUND

A speaker is an electro-acoustic transducer, and performance thereof greatly affects sound quality. As an important part in an electronic device such as a headset, performance of the speaker is more important. A moving-coil vibration system is generally used for the speaker in the headset. Due to low costs and a mature technology, the moving-coil vibration system can have relatively good sound performance in a full frequency band. However, the moving-coil vibration system inevitably brings split vibration that causes sound quality degradation, causing low high-frequency expansion. Therefore, a headset formed by combining the moving-coil vibration system and a high-frequency unit appears. This type of headset can achieve advantages of three-band equalization, a rich low frequency, a bright high frequency, and good resolution. Specifically, this type of headset includes a type using a combination of the moving-coil vibration system and a moving-iron vibration system, and a type using a combination of the moving-coil vibration system and a planar diaphragm. For both types, a thickness of the speaker is increased, causing a relatively large volume of the headset, which is not conducive to miniaturization of the headset.

### SUMMARY

This application provides a speaker and a headset, to resolve a problem that a volume of the headset is relatively large because a thickness of the speaker is relatively large, which is not conducive to miniaturization of the headset.

The technical solutions are as follows:

A first aspect of this application provides a headset, including a speaker, where the speaker includes a first magnetic body, a second magnetic body, a basket, a first voice coil, a first diaphragm, a second voice coil, and a second diaphragm;
the first magnetic body is disposed around an outer circumference of the second magnetic body, and there is a gap between the first magnetic body and the second magnetic body; the basket includes a peripheral part and a basket top connected to the peripheral part; the peripheral part is disposed around an outer circumference of the first magnetic body, and there is a first magnetic gap between the peripheral part and the first magnetic body; and the first diaphragm and the second diaphragm are separately located on two opposite sides of the basket top;
the first voice coil is connected to the first diaphragm, there is a preset gap between the first diaphragm and the basket top, the first voice coil is located in the preset gap, the first magnetic body and the basket top are combined to form a magnetic loop with the second magnetic body, and the first voice coil, the first magnetic body, the second magnetic body, and the basket top are fitted to drive the first diaphragm to vibrate; and
the second voice coil is connected to the second diaphragm, a partial structure of the second voice coil extends into the first magnetic gap, a magnetic loop is formed between the first magnetic body and the peripheral part, and the second voice coil, the first magnetic body, and the peripheral part are fitted to drive the second diaphragm to vibrate.

By using the foregoing solutions, the first diaphragm and the second diaphragm are separately disposed on the two opposite sides of the basket top, so that the first diaphragm and the second diaphragm can be separately driven by respective corresponding parts to implement vibration. After a structure formed by combining the first magnetic body and the basket top forms a magnetic loop with the second magnetic body, the first diaphragm is driven after the first voice coil is energized, to produce sound. After a magnetic loop is formed between the first magnetic body and the peripheral part, the second diaphragm is driven after the second voice coil is energized, to produce sound. A thickness direction of the speaker is parallel to a direction from the first diaphragm to the second diaphragm. In this way, although the first diaphragm and the second diaphragm are located in magnetic fields formed by different magnetic loops, the two magnetic loops share the first magnetic body and the basket. Therefore, when the speaker in this application is compared with technical solutions in which two baskets are required for both another type using a combination of a moving-coil vibration system and a moving-iron vibration system and another type using a combination of the moving-coil vibration system and a planar diaphragm, an original part that increases a thickness is reduced in the thickness direction of the speaker in this application, thereby helping reduce the thickness of the speaker. When the speaker is applied to the headset, it helps reduce a volume of the headset, thereby facilitating miniaturization of the headset.

In some implementations, the basket top has a first through hole, a partial structure of the second magnetic body extends into the first through hole, and there is a gap between the first through hole and the partial structure that is of the second magnetic body and that extends into the first through hole.

By using the foregoing solutions, after the first through hole is disposed, the second magnetic body is not in contact with the basket top, so that a role of the second magnetic body when being fitted with another part to drive the first diaphragm is enhanced, thereby improving sound quality of the speaker.

In some implementations, the first magnetic body is of a ring structure, the first magnetic body has a first side surface and a second side surface that are opposite to each other, and the basket top is in contact with the first side surface.

By using the foregoing solutions, the first magnetic body is of a ring structure, so that the first magnetic body is of a closed structure. After the first magnetic body is fitted with the second magnetic body, the first voice coil can be in a uniformly distributed magnetic field.

In some implementations, a height direction of the first magnetic body is parallel to a direction from the first side surface to the second side surface, and in the height direction of the first magnetic body, a height of the first magnetic body is not greater than a height of the second magnetic body.

By using the foregoing solutions, the second magnetic body is relatively close to the first diaphragm, so that a role of the second magnetic body when being fitted with another part to drive the first diaphragm is enhanced, thereby improving sound quality of the speaker.

In some implementations, the basket top totally covers the first side surface.

By using the foregoing solutions, magnetic conduction is performed on the first magnetic body by using the basket top, so that magnetic field strength of the gap between the first magnetic body and the second magnetic body can be increased, and a vibration amplitude of the first diaphragm can be improved.

In some implementations, the speaker further includes a film, the first voice coil is fastened to one side surface of the first diaphragm, and the film is fastened to the other opposite side surface of the first diaphragm.

By using the foregoing solutions, the film is used to ensure a high-frequency response of the speaker.

In some implementations, a side that is of the basket top and that faces the first diaphragm has a first recessed groove, and at least a partial structure of the first voice coil is capable of extending into the first recessed groove.

By using the foregoing solutions, the first recessed groove is designed. Therefore, sufficient movement space is provided for the first voice coil when the first diaphragm vibrates. In addition, it helps provide sufficient vibration space for the first diaphragm, thereby helping improve sound quality of the speaker.

In some implementations, the side that is of the basket top and that faces the first diaphragm has a recessed structure, the recessed structure is distributed around a circumference of the first recessed groove, and a first protrusion part is formed between the recessed structure and the first recessed groove; and a circumferential edge of the first diaphragm is connected to a surface of the recessed structure.

By using the foregoing solutions, it helps reduce the thickness of the speaker.

In some implementations, the speaker further includes a first fastening ring, and the circumferential edge of the first diaphragm is connected to the surface of the recessed structure by using the first fastening ring.

By using the foregoing solutions, with the first fastening ring, assembly of the first diaphragm is facilitated, and a possibility that the first diaphragm is damaged is reduced.

In some implementations, the speaker further includes a first protective cover, and the circumferential edge of the first diaphragm is sandwiched between the first protective cover and the first fastening ring.

By using the foregoing solutions, the first diaphragm system is protected by using the first protective cover, and the edge of the first diaphragm is sandwiched between the first protective cover and the first fastening ring, to help fasten the first diaphragm.

In some implementations, a first sound output hole is disposed on the first protective cover.

By using the foregoing solutions, sound produced by the first diaphragm may be transmitted to the outside of the speaker through the first sound output hole.

In some implementations, a damping fabric mesh is mounted on the first sound output hole.

By using the foregoing solutions, a component inside the speaker is protected. In addition, it helps prevent sound distortion.

In some implementations, the speaker further includes a first spring washer, the first magnetic body is located between the basket top and the first spring washer, and the first spring washer, the second voice coil, the first magnetic body, and the peripheral part are fitted to drive the second diaphragm to vibrate.

By using the foregoing solutions, the first spring washer may implement magnetic conduction, so that a relatively strong magnetic field can be generated in the first magnetic gap, thereby facilitating vibration of the second diaphragm.

In some implementations, the basket further includes a radial extension part, the peripheral part is cylindrical, the basket top is connected to one end of the peripheral part, the radial extension part is connected to the other opposite end of the peripheral part, and a second sound output hole is disposed on the radial extension part.

By using the foregoing solutions, the radial extension part is disposed and the second sound output hole is disposed thereon, so that it helps sound produced by the second diaphragm be transmitted to the outside of the speaker.

In some implementations, the speaker further includes a second protective cover, the second protective cover is connected to the basket, and a circumferential edge of the second diaphragm is sandwiched between the radial extension part and the second protective cover.

By using the foregoing solutions, the second diaphragm is protected by using the second protective cover.

In some implementations, the speaker further includes a second fastening ring, the second fastening ring is connected to the circumferential edge of the second diaphragm, and the circumferential edge of the second diaphragm is sandwiched between the second fastening ring and the second protective cover.

By using the foregoing solutions, the circumferential edge of the second diaphragm can be well fastened by using the second fastening ring and the second protective cover.

In some implementations, the basket further includes an axial extension part, the axial extension part is connected to the radial extension part, the axial extension part is in a ring shape, the second protective cover is inserted into the axial extension part, and the second fastening ring is located between the second protective cover and the radial extension part.

By using the foregoing solution, after the second protective cover is inserted into the axial extension part, it helps implement a fixed connection between the second protective cover and the basket.

In some implementations, a leakage hole is disposed on the second protective cover.

By using the foregoing solutions, the leakage hole may communicate with the outside and a cavity formed between the second protective cover and the second diaphragm. In this way, atmosphere inside the cavity can be balanced with external atmosphere.

In some implementations, a damping mesh fabric is disposed on the second sound output hole, and/or a damping mesh fabric is disposed on the leakage hole.

By using the foregoing solutions, a component inside the speaker is protected. In addition, it helps prevent sound distortion.

In some implementations, when the damping mesh fabric is disposed on the leakage hole, the second protective cover has a second recessed groove, the second recessed groove is recessed in a direction in which the second diaphragm is located, the leakage hole is located at a groove bottom of the second recessed groove, the damping mesh fabric is fastened in the second recessed groove, and an outer surface of the damping mesh fabric is flush with an outer surface of the second protective cover.

By using the foregoing solutions, the damping mesh fabric is not prone to protrude outward, thereby helping reduce the thickness of the speaker.

In some implementations, an inner surface of the second protective cover protrudes towards the direction in which the second diaphragm is located, and an inward convex structure is formed.

By using the foregoing solutions, without reducing a thickness of the second protective cover at the second recessed groove, it is convenient to mount the damping mesh fabric, and structural strength of the second protective cover at the second recessed groove is increased.

In some implementations, a frequency of sound produced by the first diaphragm is higher than a frequency of sound produced by the second diaphragm.

By using the foregoing solution, the speaker can have relatively good performance in both a low-frequency range and a high-frequency range, to help improve sound quality of the speaker.

By using the foregoing solution, the speaker can have relatively good performance in both a low-frequency range and a high-frequency range, to help improve sound quality of the speaker.

In some implementations, the first voice coil is a planar voice coil, and the second voice coil is a cylindrical voice coil.

By using the foregoing solutions, the planar voice coil is characterized by a small thickness and a small mass. In this way, transient and high-frequency characteristics are relatively good, so that it helps improve sound quality of the speaker in a high-frequency band while helping reduce the thickness of the speaker. The cylindrical voice coil is characterized by low costs and good performance.

In some implementations, a magnetization direction of the first magnetic body is opposite to a magnetization direction of the second magnetic body.

By using the foregoing solutions, it helps the first magnetic body and the basket top be fitted to form, with the second magnetic body, a magnetic loop for driving the first voice coil to vibrate.

In some implementations, the speaker further includes a circuit board, the circuit board is fastened to the basket, and the first voice coil and the second voice coil are separately electrically connected to the circuit board.

By using the foregoing solutions, it is convenient to electrically connect the speaker to another part in the headset by using the circuit board, for example, electrically connect the speaker to a battery. In this way, power can be supplied to the speaker.

In some implementations, the headset further includes a housing, and the speaker is disposed inside the housing.

By using the foregoing solutions, the housing may be used to implement wearing on a human ear. In addition, an outline of the housing may adapt to a shape of the human ear, to improve wearing comfort of a user.

A second aspect of this application provides a speaker, where the speaker includes a first magnetic body, a second magnetic body, a basket, a first voice coil, a first diaphragm, a second voice coil, and a second diaphragm;
the first magnetic body is disposed around an outer circumference of the second magnetic body, and there is a gap between the first magnetic body and the second magnetic body; the basket includes a peripheral part and a basket top connected to the peripheral part; the peripheral part is disposed around an outer circumference of the first magnetic body, and there is a first magnetic gap between the peripheral part and the first magnetic body; and the first diaphragm and the second diaphragm are separately located on two opposite sides of the basket top;
the first voice coil is connected to the first diaphragm, there is a preset gap between the first diaphragm and the basket top, the first voice coil is located in the preset gap, the first magnetic body and the basket top are combined to form a magnetic loop with the second magnetic body, and the first voice coil, the first magnetic body, the second magnetic body, and the basket top are fitted to drive the first diaphragm to vibrate; and
the second voice coil is connected to the second diaphragm, a partial structure of the second voice coil extends into the first magnetic gap, a magnetic loop is formed between the first magnetic body and the peripheral part, and the second voice coil, the first magnetic body, and the peripheral part are fitted to drive the second diaphragm to vibrate.

By using the foregoing solutions, the first diaphragm and the second diaphragm are separately disposed on the two opposite sides of the basket top, so that the first diaphragm and the second diaphragm can be separately driven by respective corresponding parts to implement vibration. After a structure formed by combining the first magnetic body and the basket top forms a magnetic loop with the second magnetic body, the first diaphragm is driven after the first voice coil is energized, to produce sound. After a magnetic loop is formed between the first magnetic body and the peripheral part, the second diaphragm is driven after the second voice coil is energized, to produce sound. A thickness direction of the speaker is parallel to a direction from the first diaphragm to the second diaphragm. In this way, although the first diaphragm and the second diaphragm are located in magnetic fields formed by different magnetic loops, the two magnetic loops share the first magnetic body and the basket. Therefore, when this application is compared with technical solutions in which two baskets are required for both another type using a combination of a moving-coil vibration system and a moving-iron vibration system and another type using a combination of the moving-coil vibration system and a planar diaphragm, an original part that increases a thickness is reduced in the thickness direction of the speaker in this application, thereby helping reduce the thickness of the speaker. When the speaker is applied to the headset, it helps reduce a volume of the headset, thereby facilitating miniaturization of the headset.

### BRIEF DESCRIPTION OF DRAWINGS

FIG. 1 is a schematic diagram of a structure of a headset according to some embodiments of this application;

FIG. 2 is an exploded view of a speaker according to some embodiments of this application;

FIG. 3 is a schematic diagram of a structure of a speaker according to some embodiments of this application;

FIG. 4 is a schematic diagram of a structure of a speaker from another perspective according to some embodiments of this application;

FIG. 5 is a schematic diagram of a structure of a speaker from still another perspective according to some embodiments of this application;

FIG. 6 is a cross-sectional view taken along a line A-A in FIG. 5;

FIG. 7 is a schematic enlarged view at B in FIG. 6;

FIG. 8 is a cross-sectional view of a speaker according to some other embodiments of this application;

FIG. 9 is a cross-sectional view of a speaker according to still some other embodiments of this application;

FIG. 10 is a schematic diagram of a structure of a first protective cover according to some embodiments of this application;

FIG. 11 is a schematic diagram of a structure of a basket according to some embodiments of this application;

FIG. 12 is a schematic diagram of a structure of a second protective cover according to some embodiments of this application;

FIG. 13 is a schematic diagram of a structure of a second protective cover from another perspective according to some embodiments of this application;

FIG. 14 is a cross-sectional view taken along a line C-C in FIG. 13;

FIG. 15 is a cross-sectional view in which a damping mesh fabric is mounted on a second protective cover according to some embodiments of this application; and

FIG. 16 is a schematic diagram of a magnetic induction line in a magnetic loop of a speaker according to some embodiments of this application.

Meanings represented by reference numerals in the accompanying drawings are respectively as follows:
100. headset; 101. housing; 102. flexible sleeve; 103. headset sound output hole; 200. speaker; 204. first magnetic body; 205. second magnetic body; 206. basket; 207. peripheral part; 208. basket top; 209. first magnetic gap; 210. first voice coil; 211. first diaphragm; 212. preset gap; 213. second voice coil; 214. second diaphragm; 216. first through hole; 217. first side surface; 218. second side surface; 219. film; 220. first recessed groove; 221. recessed structure; 222. first protrusion part; 223. first fastening ring; 224. first protective cover; 225. first intermediate part; 226. edge part; 227. first sound output hole; 228. first sound output tube; 229. arc chamfer; 230. first spring washer; 231. radial extension part; 232. second sound output hole; 233. second protective cover; 234. axial part; 235. second intermediate part; 236. second fastening ring; 237. axial extension part; 238. leakage hole; 239. damping mesh fabric; 240. second recessed groove; 241. circuit board; 242. first connection position; 243. second connection position; 244. third connection position; 245. folded ring part; 246. dome part; 247. inward convex structure.

### DESCRIPTION OF EMBODIMENTS

To make the objectives, technical solutions, and advantages of this application clearer, the following further describes implementations of this application in detail with reference to the accompanying drawings.

It should be understood that “a plurality of” mentioned in this application means two or more. In the descriptions of this application, unless otherwise stated, “/” means “or”. For example, A/B may indicate A or B. The term “and/or” in this specification is merely an association relationship for describing associated objects, and indicates that three relationships may exist. For example, A and/or B may indicate the following three cases: Only A exists, both A and B exist, and only B exists. In addition, to clearly describe the technical solutions of this application, words such as “first” and “second” are used to distinguish between same items or similar items with basically the same functions and effects. A person skilled in the art may understand that the words such as “first” and “second” do not limit a quantity or an execution sequence, and the words such as “first” and “second” do not define a definite difference. The following describes in detail a headset and a speaker that are provided in embodiments of this application.

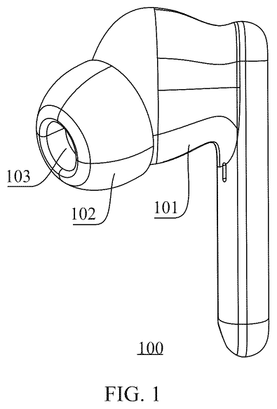

Referring to FIG. 1, in one or more embodiments, this application provides a headset 100. The headset 100 may be a wireless headset or a wired headset. The headset 100 may be used in conjunction with an electronic device such as a mobile phone, a tablet computer, a notebook computer, or a smartwatch, to convert, into mechanical vibration, an electrical signal received from the electronic device, so that the headset 100 can produce sound. It should be noted that, for the headset 100 that further has a microphone, the headset 100 may also convert mechanical vibration into an electrical signal, and send a corresponding electrical signal to the electronic device.

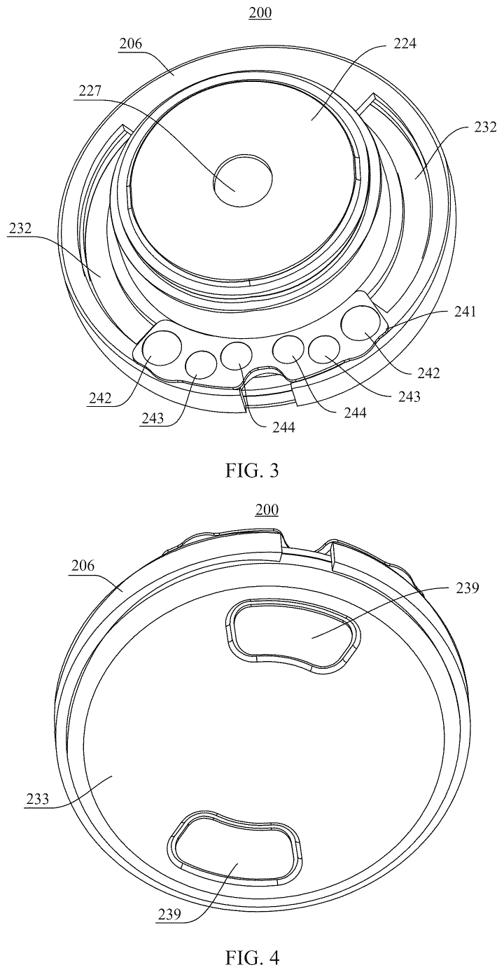

For example, with reference to FIG. 1 and FIG. 3, that the headset 100 is a wireless headset is used as an example for specific description in this application. The headset 100 includes a housing 101, a mainboard, a battery, and a speaker 200.

The housing 101 may be used as a carrier of a functional component of the headset 100. The housing 101 may implement wearing on a human ear, and an outline of the housing 101 may adapt to a shape of the human ear, to improve wearing comfort of a user. To improve comfort of the user in wearing the headset 100, the headset 100 may be further provided with a flexible sleeve 102, and the flexible sleeve 102 may be configured to be in contact with an ear of the user. An outline of the flexible sleeve 102 may be similar to a shape of a human ear canal, to improve adaptation of wearing the headset 100. In addition, the flexible sleeve 102 may be made of a flexible material such as silicone or rubber, to improve comfort of the user in wearing the headset 100. The housing 101 has a headset sound output hole 103. A sound output channel of the speaker 200 communicates with the headset sound output hole 103.

It should be noted that FIG. 1 only schematically shows some parts included in the headset 100. Actual shapes, actual sizes, actual positions, and actual structures of these parts are not limited by FIG. 1 and the following accompanying drawings.

The mainboard (not shown) is mounted inside the housing 101. The mainboard (not shown) is configured to integrate a main control chip, a Bluetooth chip, and the like, and may be used for charging management, signal transmission, and the like. The mainboard may be a rigid printed circuit board, a flexible printed circuit board, or a rigid-flexible printed circuit board. The battery (not shown) is mounted inside the housing 101. The battery may supply power to an electronic component such as the mainboard and the speaker 200 in the headset 100. The speaker 200 is disposed inside the housing 101.

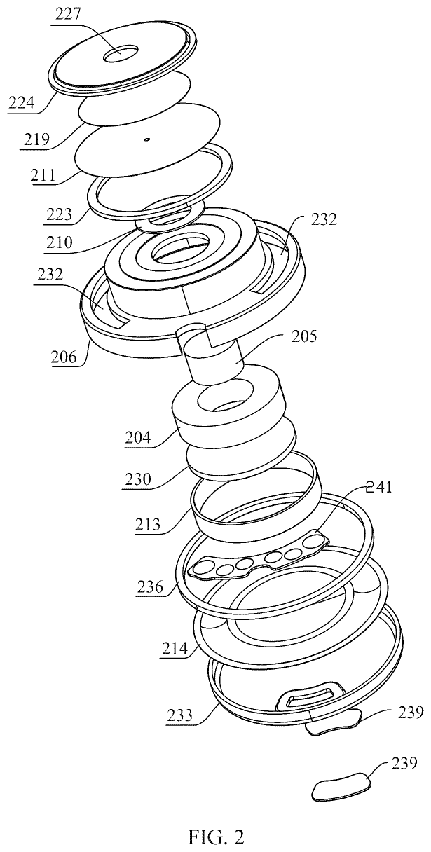

With reference to FIG. 2 and FIG. 6, in some embodiments, the speaker 200 includes a first magnetic body 204, a second magnetic body 205, a basket 206, a first voice coil 210, a first diaphragm 211, a second voice coil 213, and a second diaphragm 214. The first magnetic body 204 is disposed around an outer circumference of the second magnetic body 205, and there is a gap between the first magnetic body 204 and the second magnetic body 205. The basket 206 includes a peripheral part 207 and a basket top 208 connected to the peripheral part 207. The peripheral part 207 is disposed around an outer circumference of the first magnetic body 204, and there is a first magnetic gap 209 between the peripheral part 207 and the first magnetic body 204. The basket top 208 is located between the first magnetic body 204 and the first diaphragm 211. The basket top has two opposite side surfaces. The first diaphragm 211 and the second diaphragm 214 are separately located on the two opposite side surfaces of the basket top 208. The first voice coil 210 is fixedly connected to the first diaphragm 211. There is a preset gap 212 between the first diaphragm 211 and the basket top 208, that is, the first diaphragm 211 is spaced apart from the basket top 208. The first voice coil 210 is located in the preset gap 212. A structure formed by combining the first magnetic body 204 and the basket top 208 forms a magnetic loop with the second magnetic body 205. The first voice coil 210, the first magnetic body 204, the second magnetic body 205, and the basket top 208 are fitted to drive the first diaphragm 211 to vibrate. The second voice coil 213 is fixedly connected to the second diaphragm 214. A partial structure of the second voice coil 213 extends into the first magnetic gap 209. A magnetic loop is formed between the first magnetic body 204 and the peripheral part 207. The second voice coil 213, the first magnetic body 204, and the peripheral part 207 are fitted to drive the second diaphragm 214 to vibrate. The first diaphragm 211 and the second diaphragm 214 are separately located on the two opposite side surfaces of the basket top 208.

It should be noted that the speaker 200 is not merely used in the headset 100. In some other possible implementations, the speaker 200 may also be applied to a mobile phone, a tablet computer, a notebook computer, a smartwatch, or the like.

According to the speaker 200 in this embodiment of this application, the first diaphragm 211 and the second diaphragm 214 are separately disposed on the two opposite side surfaces of the basket top 208, so that the first diaphragm 211 and the second diaphragm 214 can be separately driven by respective corresponding parts to implement vibration. After the structure formed by combining the first magnetic body 204 and the basket top 208 forms a magnetic loop with the second magnetic body 205, the first diaphragm 211 is driven after the first voice coil 210 is energized, to produce sound. The first diaphragm 211 is mainly driven through fitting between the first voice coil 210, the first magnetic body 204, the second magnetic body 205, and the basket top 208. After a magnetic loop is formed between the first magnetic body 204 and the peripheral part 207, the second diaphragm 214 is driven after the second voice coil 213 is energized, to produce sound. The second diaphragm 214 is mainly driven through fitting between the second voice coil 213, the first magnetic body 204, and the peripheral part 207. A thickness direction of the speaker 200 is parallel to a direction from the first diaphragm 211 to the second diaphragm 214. In this way, when the two magnetic loops share the first magnetic body 204 and the basket 206, compared with another type using a combination of a moving-coil vibration system and a moving-iron vibration system and another type using a combination of the moving-coil vibration system and a planar diaphragm, an original part that increases a thickness is reduced in the thickness direction of the speaker 200 in this application, thereby helping reduce the thickness of the speaker 200. The basket top 208 is fitted with the first magnetic body 204. In this way, when the basket top 208 performs magnetic conduction on the first magnetic body 204 or the basket top 208 is a magnetic body, it helps enhance magnetism of the first magnetic body 204. In addition, it helps the peripheral part 207 perform magnetic conduction on the first magnetic body 204 or the peripheral part 207 have magnetism, to form a magnetic loop with the first magnetic body 204. When the speaker 200 is applied to the headset 100, it helps reduce a volume of the headset 100, thereby facilitating miniaturization of the headset 100. In addition, the speaker 200 is characterized by three-band equalization, a rich low frequency, a bright high frequency, and good resolution.

With reference to FIG. 2 and FIG. 6, in some embodiments, the first voice coil 210 and the second voice coil 213 are separately located on the two opposite side surfaces of the basket top 208, the first diaphragm 211 and the first voice coil 210 are located on a same side of the basket top 208, and the second diaphragm 214 and the second voice coil 213 are located on a same side of the basket top 208. The second magnetic body 205 is of a cylindrical structure. For example, the second magnetic body 205 is of a circular cylindrical structure. Certainly, the second magnetic body 205 may be of a structure in another shape, or may be of an elliptical cylindrical structure, a prismatic structure, or the like. The first magnetic body 204 is magnetic steel or a magnet, and the second magnetic body 205 is magnetic steel or a magnet. The first magnetic body 204 may be of a ring structure. For example, the first magnetic body 204 is of a circular ring structure. Certainly, the first magnetic body 204 may be in another closed shape. For example, an outer contour of the first magnetic body 204 is a polygon. In this way, the first magnetic body 204 is of a closed structure. After the first magnetic body 204 is fitted with the second magnetic body 205, the first voice coil 210 can be in a uniformly distributed magnetic field. The second magnetic body 205 is located in a ring of the first magnetic body 204, and the second magnetic body 205 is spaced apart from the first magnetic body 204, that is, a maximum diameter of the second magnetic body 205 is less than a diameter of an inner ring of the first magnetic body 204. The first magnetic body 204 is of an integral structure.

It should be noted that, in some other possible implementations, the first magnetic body 204 may include a plurality of first sub-magnetic bodies that are spaced apart, and the plurality of first sub-magnetic bodies are evenly distributed by being spaced apart around the outer circumference of the second magnetic body 205.

With reference to FIG. 2 and FIG. 6, in some embodiments, a material of the basket 206 is a magnetically conductive material, the magnetically conductive material may be magnetically conductive metal, and the magnetically conductive metal is iron, cobalt, or nickel. In addition, a surface of the basket 206 may be electroplated or galvanized in multicolor to prevent the basket 206 from being rusted. The basket top 208 and the peripheral part 207 are of an integral structure, and the peripheral part 207 may be of a ring structure. For example, the peripheral part 207 is of a circular ring structure. Certainly, an outer contour of the peripheral part 207 may be in another shape, for example, a polygon. When the peripheral part 207 is of a ring structure, a cylindrical structure is formed after the peripheral part 207 extends by a specific length in an axial direction of a ring, and the basket top 208 is connected to one end of the peripheral part 207. Both the first magnetic body 204 and the second magnetic body 205 are located in a cavity formed by the peripheral part 207 and the basket top 208 together. The first magnetic body 204 and the second magnetic body 205 are both located on an inner side of the basket top 208, and the first diaphragm 211 and the first voice coil 210 are located on an outer side of the basket top 208. The first voice coil 210 may be fixedly connected to the first diaphragm 211 in a manner of bonding, and both the basket top 208 and the second magnetic body 205 are spaced apart from the first diaphragm 211. The second voice coil 213 is fixedly connected to the second diaphragm 214 in a manner of bonding, and the second voice coil 213 is not in contact with the first magnetic body 204 and an outer ring part. The first diaphragm 211, the second diaphragm 214, the first voice coil 210, and the second voice coil 213 may be disposed on a same center line, and an axis of the second magnetic body 205 passes through the center of each of the first diaphragm 211 and the second diaphragm 214. It should be noted that, in some other possible implementations, at least the basket top 208 of the basket 206 is a magnet or magnetic steel, and the peripheral part 207 is a magnet or magnetic steel.

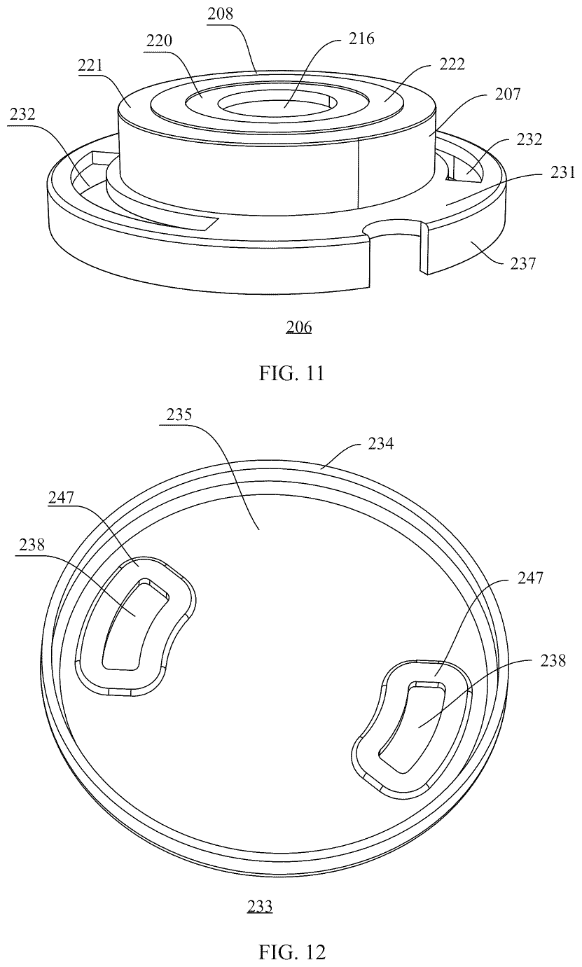

With reference to FIG. 6 and FIG. 11, in some embodiments, the basket top 208 has a first through hole 216, a partial structure of the second magnetic body 205 extends into the first through hole 216, and there is a gap between the first through hole 216 and the partial structure that is of the second magnetic body 205 and that extends into the first through hole 216. In this way, after the first through hole 216 is disposed, the second magnetic body 205 is not in contact with the basket top 208, so that a role of the second magnetic body 205 when being fitted with another part to drive the first diaphragm 211 is enhanced, thereby improving sound quality of the speaker 200. In an embodiment, the first through hole 216 may be a circular hole, and the second magnetic body 205 is spaced apart from the first through hole 216. In this way, it helps the basket top 208 and the first magnetic body 204 be combined to form a magnetic loop with the second magnetic body 205. Certainly, the first through hole 216 may be designed as a through hole in another shape based on a requirement, for example, a polygonal through hole.

With reference to FIGS. 6 and 16, in some embodiments, the first magnetic body 204 has a first side surface 217 and a second side surface 218 that are opposite to each other. The basket top 208 is in contact with the first side surface 217, and the second side surface 218 faces the second diaphragm 214. Because the basket top 208 is connected to the peripheral part 207, this is equivalent to that the first side surface 217 of the first magnetic body 204 is connected, that is, indirectly connected, to the peripheral part 207. Therefore, a magnetic loop for implementing a diaphragm of the second diaphragm 214 can be formed between the second side surface 218 of the first magnetic body 204 and the peripheral part 207. FIG. 16 is a partial cross-sectional view of a speaker, and some parts are hidden (for example, only the first voice coil 210 is shown, and the first diaphragm is not shown), so that magnetic induction lines are clearly shown, and distribution of the magnetic induction lines is merely an example. In this way, the basket top 208 performs magnetic conduction on the first magnetic body 204, so that the basket top 208 and the first magnetic body 204 are combined to form a magnetic loop with the second magnetic body 205. A direction of magnetic induction lines of the partial structure that is of the second magnetic body 205 and that extends into the first through hole 216 points to an inner wall of the first through hole 216 of the basket top 208. The first voice coil 210 is suspended in a magnetic field. When the first voice coil 210 is energized, the first voice coil 210 drives the first diaphragm 211 to vibrate under an action of the magnetic field. Because the basket 206 is made of a magnetically conductive material, and the basket top 208 of the basket 206 is in contact with the first magnetic body 204, magnetism of the first magnetic body 204 is enhanced. In this way, when the first voice coil 210 is located in the magnetic field and is energized, it helps improve an amplitude of the first diaphragm 211. In an embodiment, the basket top 208 is fastened to the first side surface 217 in a manner of bonding. In addition, the basket top 208 and the peripheral part 207 are of an integral structure, and the basket top 208 is in contact with the first magnetic body 204. In this way, when the basket top 208 performs magnetic conduction on the first magnetic body 204, it helps enhance magnetism of the first magnetic body 204, and the first magnetic body 204 and the basket top 208 are fitted to form, with the second magnetic body 205, a magnetic loop for implementing vibration of the first diaphragm 211. In addition, it helps the peripheral part 207 perform magnetic conduction on the first magnetic body 204, so that a magnetic loop for implementing vibration of the second diaphragm 214 can be formed between the peripheral part 207 and the first magnetic body 204.

With reference to FIG. 6 and FIG. 11, in some embodiments, a height direction of the first magnetic body 204 is parallel to a direction from the first side surface 217 to the second side surface 218. In the height direction of the first magnetic body 204, a height of the first magnetic body 204 is not greater than a height of the second magnetic body 205. In this way, the second magnetic body 205 is relatively close to the first diaphragm 211, so that a role of the second magnetic body 205 when being fitted with another part to drive the first diaphragm 211 is enhanced, thereby improving sound quality of the speaker 200, and also helping reduce the thickness of the speaker 200. In an embodiment, the height of the first magnetic body 204 is less than the height of the second magnetic body 205, the second magnetic body 205 extends into the first through hole 216, and the top of the second magnetic body 205 exceeds the first side surface 217 of the first magnetic body 204. In this way, it helps distribution of magnetic induction lines between the second magnetic body 205 and the basket top 208 move upward in a direction in which the first voice coil 210 is located, so that the first voice coil 210 is located in a region with dense magnetic induction lines between the second magnetic body 205 and the basket top 208. In this way, when the first voice coil 210 is energized, it helps improve the vibration amplitude of the first diaphragm 211. In addition, the first magnetic body 204 is in contact with the basket top 208, so that the magnetic induction lines are distributed densely near a side that is of the basket top 208 and that faces the first diaphragm 211 (that is, if a distance to the side that is of the basket top 208 and that faces the first diaphragm 211, the magnetic induction lines are distributed more densely). The second magnetic body 205 is greater than the first magnetic body 204. In this way, it helps the first voice coil 210 be located in a region with densely distributed magnetic induction lines in the magnetic loop, thereby improving the vibration amplitude of the first diaphragm, and helping improve high-frequency sound quality of the speaker 200. The top of the second magnetic body 205 may not extend out of the basket top 208. In this way, it helps ensure that the vibration amplitude of the first diaphragm 211 is not excessively large, and reduce a possibility that the first diaphragm 211 is in contact with the second magnetic body 205 during vibration, and it also helps ensure a service life of the first diaphragm 211.

Referring to FIG. 6, in some embodiments, the basket top 208 totally covers the first side surface 217. In this way, the basket top 208 performs magnetic conduction on the first magnetic body 204, so that magnetic field strength of the gap between the first magnetic body 204 and the second magnetic body 205 can be increased, and the vibration amplitude of the first diaphragm 211 can be improved. In addition, because the basket top 208 is in full contact with the first side surface 217 of the first magnetic body 204, it helps increase connection strength between the basket top 208 and the first magnetic body 204, thereby increasing a possibility that the speaker 200 is not prone to be damaged when the headset drops, that is, the first magnetic body 204 is not prone to be separated from the basket 206, thereby ensuring integrity of quality and performance of the speaker. In addition, in this embodiment of this application, the basket top 208 of the basket 206 is basically in full contact with the first side surface 217 of the first magnetic body 204. Therefore, it also helps increase magnetic field strength between the first magnetic body 204 and the peripheral part 207 of the basket 206 while connection strength is ensured, thereby helping improve a vibration amplitude of the second diaphragm 214. The first magnetic body 204 is in contact with the basket top 208. Therefore, to ensure a vibration amplitude of the first voice coil 210, the height of the second magnetic body 205 is greater than the height of the first magnetic body 204, so that the second magnetic body 205 also moves closer to the direction in which the first voice coil 210 is located.

In an embodiment, the basket top 208 is bonded and fastened to the first side surface 217 of the first magnetic body 204. A diameter of the first through hole 216 is equal to the diameter of the inner ring of the first magnetic body 204 that is in a ring shape, and the first voice coil 210 may be in a ring shape. For example, the first voice coil 210 is in a circular ring shape. A diameter of the second magnetic body 205 is greater than a diameter of an inner ring of the first voice coil 210, and the diameter of the second magnetic body 205 is less than a diameter of an outer ring of the first voice coil 210. In this way, it helps the first voice coil 210 well drive the first diaphragm 211 to move. It should be noted that, in some other possible implementations, the basket top 208 may alternatively cover more than half of the first side surface 217, that is, the diameter of the first through hole 216 is not greater than half of a sum of the diameter of the inner ring of the first magnetic body 204 and a diameter of an outer ring thereof. In this way, connection strength between the basket top 208 and the first magnetic body 204 may also be enhanced. A part that is on the first side surface 217 of the first magnetic body 204 and that is not covered by the basket top 208 may also extend in the direction in which the first voice coil 210 is located, to form a ring protrusion with a specific height. The ring protrusion is spaced apart from the second magnetic body 205, and the ring protrusion is disposed around the outer circumference of the second magnetic body 205. In this way, it also helps ensure the vibration amplitude of the first diaphragm 211 group.

With reference to FIG. 6 and FIG. 7, in some embodiments, the speaker 200 further includes a film 219, the first voice coil 210 is fastened to one side surface of the first diaphragm 211, and the film 219 is fastened to the other opposite side surface of the first diaphragm 211. In this way, the film 219 is used to ensure a high-frequency response of the speaker 200. In an embodiment, the film 219 may be fixedly connected to the first diaphragm 211 in a manner of bonding or the like. The first voice coil 210 faces the basket top 208. The film 219 may be of a planar structure or a dome structure, and a surface of the dome structure is a curved surface. The curved surface may be a spherical surface, or certainly may be a curved surface in another form, for example, a curved surface whose curvature gradually changes. The center of the film 219, the center of the first diaphragm 211, and the center of the second diaphragm 214 are located on a same center line.

With reference to FIG. 6 and FIG. 7, in some embodiments, a side that is of the basket top 208 and that faces the first diaphragm 211 has a first recessed groove 220, and at least a partial structure of the first voice coil 210 is capable of extending into the first recessed groove 220. The first recessed groove 220 is designed. Therefore, sufficient movement space is provided for the first voice coil 210 when the first diaphragm 211 vibrates. In addition, it helps provide sufficient vibration space for the first diaphragm 211, thereby helping improve sound quality of the speaker 200. In an embodiment, the first recessed groove 220 is in a circular ring shape, and a diameter of an outer ring of the first recessed groove 220 is greater than the diameter of the outer ring of the first voice coil 210, so that the first voice coil 210 can extend into the first recessed groove 220, and a top surface of the second magnetic body 205 can be flush with a groove bottom of the first recessed groove 220. Certainly, in some other possible implementations, on the premise that the vibration amplitude of the first diaphragm 211 is ensured, the top surface of the second magnetic body 205 may alternatively extend out of a groove bottom surface of the first recessed groove 220. In this way, it helps the first voice coil 210 be located in a region with densely distributed magnetic induction lines in the magnetic loop, thereby improving the vibration amplitude of the first diaphragm, and helping improve high-frequency sound quality of the speaker 200.

With reference to FIG. 6 and FIG. 11, in some embodiments, the side that is of the basket top 208 and that faces the first diaphragm 211 has a recessed structure 221, the recessed structure 221 is distributed around a circumference of the first recessed groove 220, and a first protrusion part 222 is formed between the recessed structure 221 and the first recessed groove 220. A circumferential edge of the first diaphragm 211 is connected to a surface of the recessed structure 221. In this way, it helps reduce the thickness of the speaker 200.

With reference to FIG. 2 and FIG. 6, in some embodiments, the speaker 200 further includes a first fastening ring 223, and the circumferential edge of the first diaphragm 211 is connected to the surface of the recessed structure 221 by using the first fastening ring 223. In this way, assembly of the first diaphragm 211 is facilitated, and a possibility of damage to the first diaphragm 211 is reduced. In an embodiment, the first diaphragm 211 is fixedly connected to the first fastening ring 223. For example, the connection may be implemented in a manner of bonding or an integral connection. In this way, the first diaphragm 211 and the first fastening ring 223 may form an integral part, so that the first diaphragm 211 is fastened to the basket 206. A connection manner between the first fastening ring 223 and the basket top 208 may be a fixed connection in a manner of bonding or welding.

With reference to FIG. 2, FIG. 6, and FIG. 11, in some embodiments, the speaker 200 further includes a first protective cover 224, and the circumferential edge of the first diaphragm 211 is sandwiched between the first protective cover 224 and the first fastening ring 223. In this way, the first diaphragm 211 system is protected by using the first protective cover 224, and the edge of the first diaphragm 211 is sandwiched between the first protective cover 224 and the first fastening ring 223, to help fasten the first diaphragm 211. In an embodiment, the first protective cover 224 is fixedly connected to the first diaphragm 211, the first protective cover 224 includes a first intermediate part 225 and an edge part 226 circumferentially around the first intermediate part 225, the edge part 226 and the first intermediate part 225 are of an integral structure, the edge part 226 is in a ring shape, and the edge part 226 is fixedly connected to the first diaphragm 211. The film 219 is located in a cavity formed between the first diaphragm 211 and the first intermediate part 225. The first protective cover 224 may be molded in a manner of stamping. In this way, there is a height difference between the edge part 226 and the first intermediate part 225. Therefore, after the edge part 226 is fixedly connected to the first diaphragm 211, there is a gap between the first intermediate part 225 and the film 219, so that it helps the first diaphragm 211 drive the film 219 to vibrate together, to provide relatively large movement space for vibration of the first diaphragm 211.

Referring to FIG. 10, in some embodiments, a first sound output hole 227 is disposed on the first protective cover 224, so that sound produced by the first diaphragm 211 can be transmitted to the outside of the speaker 200 through the first sound output hole 227. The first sound output hole 227 may be disposed on the first intermediate part 225, and a shape of the first sound output hole 227 may be a circle, an ellipse, or an arc. In addition, there may be one or more first sound output holes 227.

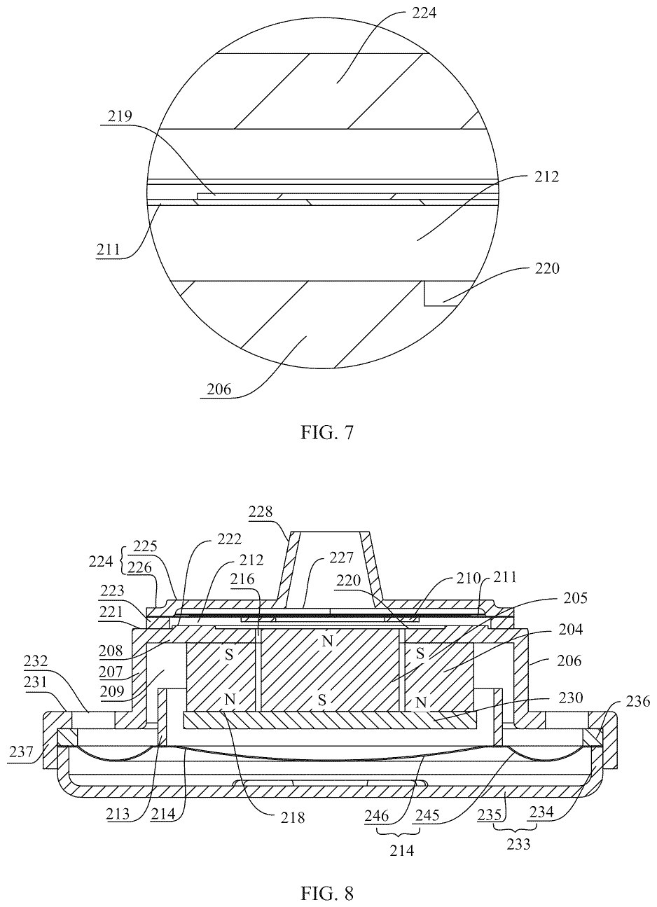

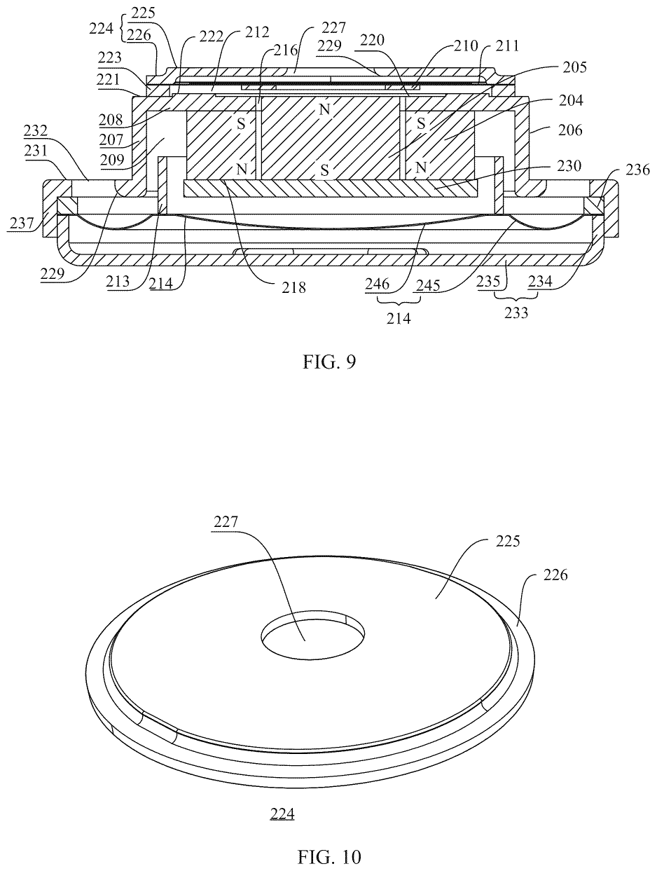

It should be noted that, in some other possible implementations, referring to FIG. 8, the first sound output hole 227 may communicate with a first sound output tube 228, and the first intermediate part 225 is located between the sound output tube and the first diaphragm 211. The first sound output tube 228 helps improve sound quality of the speaker 200. The first sound output tube 228 may be tapered, the first sound output tube 228 includes a first end and a second end, the first end communicates with the first sound output hole 227, and an inner diameter of the first sound output tube 228 gradually decreases in a direction from the first end to the second end. In still some other possible implementations, referring to FIG. 9, a hole edge of the first sound output hole 227 is in a form of an arc chamfer 229. In this way, it helps form a Coanda surface, so that sound propagates into the first sound output hole 227, thereby reducing damping. For example, the first sound output tube 228 and the first protective cover 224 may be integrally injection molded. Therefore, connection strength between the first sound output tube 228 and the first protective cover 224 can be increased, and assembly difficulty can be reduced. Certainly, the first sound output tube 228 and the first protective cover 224 may be of a separate structure. For example, the first sound output tube 228 may be disposed on the first protective cover 224 in a manner of adhesive, clamping, or a threaded connection.

With reference to FIG. 2 and FIG. 6, in some embodiments, the speaker 200 further includes a first spring washer 230, the first magnetic body 204 is located between the basket top 208 and the first spring washer 230, and the first spring washer 230, the second voice coil 213, the first magnetic body 204, and the peripheral part 207 are fitted to drive the second diaphragm 214 to vibrate. The first spring washer 230 may implement magnetic conduction, so that the first magnetic gap 209 can generate a relatively strong magnetic field, thereby facilitating vibration of the second diaphragm 214. In an embodiment, the first diaphragm 211 and the second diaphragm 214 are separately located on two sides of a whole formed by the first magnetic body 204, the second magnetic body 205, and the first spring washer 230. The second diaphragm 214 is located on one side of the first spring washer 230, and both the first magnetic body 204 and the second magnetic body 205 are located on the other opposite side of the first spring washer 230. The first magnetic body 204 and the second magnetic body 205 are separately fixedly connected to the first spring washer 230. The second side surface 218 of the first magnetic body 204 is connected to the first spring washer 230. A material of the first spring washer 230 is a magnetically conductive material, the magnetically conductive material may be magnetically conductive metal, and the magnetically conductive metal is iron, cobalt, or nickel. In addition, a surface of the first spring washer 230 may be electroplated or galvanized in multicolor to prevent the first spring washer 230 from being rusted. The first spring washer 230 is circular, a diameter of the first spring washer 230 is not less than the diameter of the outer ring of the first magnetic body 204, and the diameter of the first spring washer 230 is less than a diameter of the second voice coil 213. In this way, when moving in the first magnetic gap 209, the second voice coil 213 is prevented from being in contact with the first spring washer 230. Certainly, in some other possible implementations, the first spring washer 230 may be polygonal. Referring to FIG. 16, the first side surface 217 of the first magnetic body 204 is in contact with the basket top 208, and the basket top 208 is fixedly connected to the peripheral part 207. In this way, the first magnetic body 204 may perform magnetic conduction on the peripheral part 207. In addition, the second side surface 218 of the first magnetic body 204 is in contact with the first spring washer 230 to perform magnetic conduction on the first spring washer 230, so that a magnetic loop is formed between the peripheral part 207 and each of the first spring washer 230 and the first magnetic body 204. After the second voice coil 213 extends into the first magnetic gap 209, and when the second voice coil 213 is energized, the second voice coil 213 drives the second diaphragm 214 to vibrate under an action of the magnetic field. In addition, the first spring washer 230 performs magnetic conduction on the first magnetic body 204. Therefore, magnetic induction lines are constrained near the surface of the first spring washer 230, so that magnetic induction lines are densely distributed on a side that is of the first spring washer 230 and that is opposite to the peripheral part 207. In this way, the second voice coil 213 is in a region with densely distributed magnetic induction lines in the magnetic loop, thereby improving the vibration amplitude of the second diaphragm 214, and helping improving low-frequency sound quality of the speaker 200. The first spring washer 230 is of a sheet-like structure, and both the first magnetic body 204 and the second magnetic body 205 are located on one side of the first spring washer 230. It should be noted that, in some other embodiments, a third magnetic body may be fastened on the other opposite side of the first spring washer 230. The third magnetic body is magnetic steel or a magnet.

With reference to FIG. 2, FIG. 6, and FIG. 11, in some embodiments, the basket 206 further includes a radial extension part 231, the radial extension part 231 is connected to the other opposite end of the peripheral part 207, and a second sound output hole 232 is disposed on the radial extension part 231. In this way, it helps sound produced by the second diaphragm 214 be transmitted to the outside of the speaker 200 through the second sound output hole 232. After the radial extension part 231 is disposed, it helps use the second diaphragm 214 with a large area. An area of the first diaphragm 211 is less than or equal to the area of the second diaphragm 214. In an embodiment, the second sound output hole 232 may be strip-shaped, for example, arc-shaped. Certainly, the second sound output hole 232 may be circular. There are a plurality of second sound output holes 232, and the plurality of second sound output holes 232 are evenly distributed on the radial extension part 231. A hole edge of the second sound output hole 232 is in a form of the arc chamfer 229. In this way, it helps form a Coanda surface, so that sound propagates into the second sound output hole, thereby reducing damping. The sound output channel of the speaker 200 includes the first sound output hole 227 and the second sound output hole 232, and both the first sound output hole 227 and the second sound output hole 232 may face the headset sound output hole 103 of the headset 100. It should be noted that, the radial extension part 231 also participates in driving the second diaphragm, that is, a structure formed by combining the first spring washer 230 and the first magnetic body 204 forms a magnetic loop with a structure formed by combining the peripheral part 207 and the radial extension part 231. After the second voice coil 213 extends into the first magnetic gap 209, and when the second voice coil 213 is energized, the second voice coil 213 drives the second diaphragm 214 to vibrate under an action of the magnetic field.

With reference to FIG. 2, FIG. 6, and FIG. 12, in some embodiments, the speaker 200 further includes a second protective cover 233, the second protective cover 233 is connected to the basket 206, and a circumferential edge of the second diaphragm 214 is sandwiched between the radial extension part 231 and the second protective cover 233. In this way, the second diaphragm 214 is protected by using the second protective cover 233. In an embodiment, the second protective cover 233 includes an axial part 234 and a second intermediate part 235, the axial part 234 extends in a height direction of the speaker 200, and the axial part 234 and the second intermediate part 235 are of an integral structure.

With reference to FIG. 2 and FIG. 6, in some embodiments, the speaker 200 further includes a second fastening ring 236, the second fastening ring 236 is connected to the circumferential edge of the second diaphragm 214, and the circumferential edge of the second diaphragm 214 is sandwiched between the second fastening ring 236 and the second protective cover 233. In this way, the circumferential edge of the second diaphragm 214 can be well fastened by using the second fastening ring 236 and the second protective cover 233. In an embodiment, the second diaphragm 214 is fixedly connected to the second fastening ring 236. For example, the connection may be implemented in a manner of bonding or an integral connection. The second diaphragm 214 includes a folded ring part 245 and a dome part 246. The folded ring part 245 and the dome part 246 may be of an integral structure, or may be fixedly connected in a manner of bonding. A connection part between the folded ring part 245 and the dome part 246 is fixedly connected to the second voice coil 213. The folded ring part 245 is fixedly connected to the second fastening ring 236, and the folded ring part 245 may be fastened to the second fastening ring 236 in a manner of bonding or an integral connection. It should be noted that, in some other possible implementations, the first protective cover 224 and the second protective cover 233 may be omitted, to save costs, and the film 219 may be also omitted to save costs. Certainly, the dome part 246 of the second diaphragm 214 may also be replaced by a diaphragm structure in another form.

With reference to FIG. 2, FIG. 6, and FIG. 11, in some embodiments, the basket 206 further includes an axial extension part 237, the axial extension part 237 is connected to the radial extension part 231, the axial extension part 237 is in a ring shape, the second protective cover 233 is inserted into the axial extension part 237, and the second fastening ring 236 is located between the second protective cover 233 and the radial extension part 231. After the second protective cover 233 is inserted into the axial extension part 237, it helps implement a fixed connection between the second protective cover 233 and the basket 206. In an embodiment, the axial part 234 of the second protective cover 233 is inserted into the axial extension part 237 that is in a ring shape, and the axial part 234 may be fixedly connected to the axial extension part 237 in a manner of an interference fit and/or bonding. The basket top 208, the peripheral part 207, the radial extension part 231, and the axial extension part 237 of the basket 206 are of an integral structure, thereby improving overall structure stability of the basket 206.

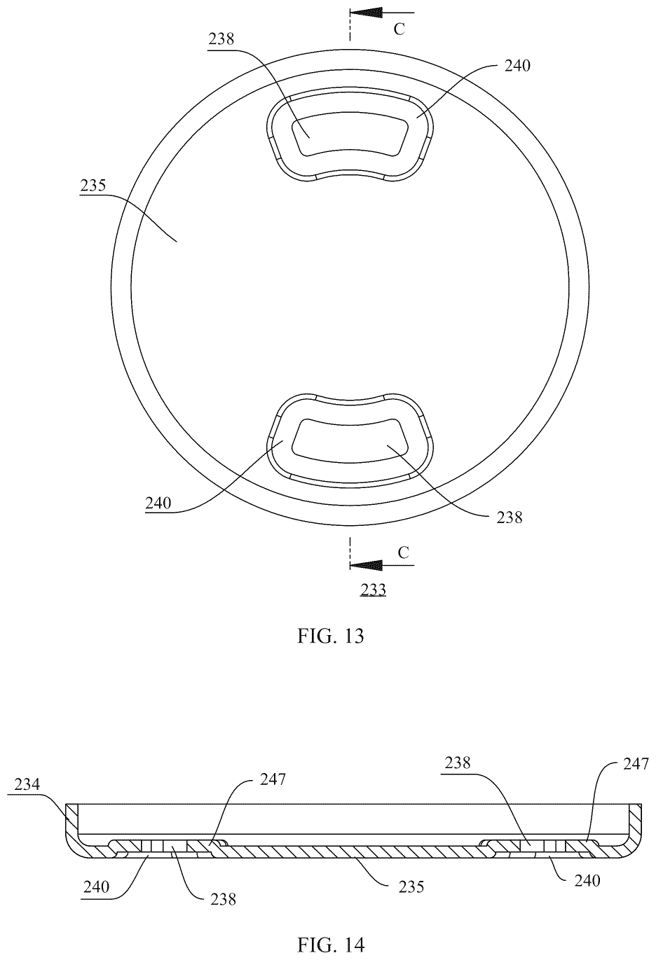

With reference to FIG. 12, FIG. 13, and FIG. 14, in some embodiments, a leakage hole 238 is disposed on the second protective cover 233, and the leakage hole 238 may communicate with the outside and a cavity formed between the second protective cover 233 and the second diaphragm 214. In this way, atmosphere inside the cavity can be balanced with external atmosphere. The leakage hole 238 is a through hole. There may be one or more leakage holes 238. When there are a plurality of leakage holes 238, the plurality of leakage holes 238 are evenly distributed on the second intermediate fabric of the second protective cover 233, for example, may be symmetrically distributed.

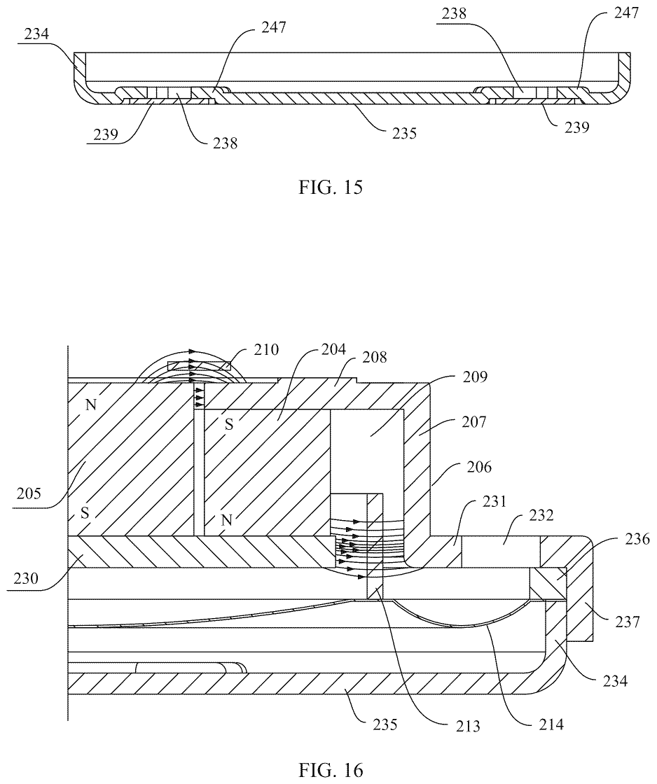

In some embodiments, a damping mesh fabric 239 may also be fastened to each of the first sound output hole 227, the second sound output hole 232, and the leakage hole 238 (referring to FIG. 4 and FIG. 15), where only the damping mesh fabric 239 at the leakage hole 238 is shown. In this way, a component inside the speaker 200 is protected. In addition, it helps prevent sound distortion. With reference to FIG. 12, FIG. 13, and FIG. 14, in an embodiment, the second protective cover 233 has a second recessed groove 240, the second recessed groove 240 is recessed in a direction in which the second diaphragm 214 is located, the leakage hole 238 is located in a groove bottom of the second recessed groove 240, and the damping mesh fabric 239 is fastened in the second recessed groove 240 in a manner of bonding. In this way, the damping mesh fabric 239 can be flush with an outer surface of the second intermediate part 235 of the second protective cover 233, thereby helping reduce the thickness of the speaker 200. For example, after the second recessed groove 240 is recessed on the second protective cover 233 in the direction in which the second diaphragm 214 is located, an inner surface of the second intermediate part 235 protrudes towards the direction in which the second diaphragm 214 is located, to form an inward convex structure 247. In this way, without reducing a thickness of the second intermediate part 235 at the second recessed groove 240, it is convenient to mount the damping mesh fabric 239, and structural strength of the second intermediate part 235 at the second recessed groove 240 is increased.

In some embodiments, a frequency of sound produced by the first diaphragm 211 is higher than a frequency of sound produced by the second diaphragm 214. In this way, the first vibration film produces high-frequency sound, and the second vibration film produces low-frequency sound, so that the speaker 200 has relatively good performance in both a low-frequency range and a high-frequency range, to help improve sound quality of the speaker 200.

In some embodiments, the first voice coil 210 is a planar voice coil, and the planar voice coil is characterized by a small thickness and a small mass. In this way, transient and high-frequency characteristics are relatively good, so that it helps improve sound quality of the speaker 200 in a high-frequency band while helping reduce the thickness of the speaker 200. The second voice coil 213 is a cylindrical voice coil, and the cylindrical voice coil is characterized by low costs and good performance.

As shown in FIG. 6, in some embodiments, a magnetization direction of the first magnetic body 204 is opposite to a magnetization direction of the second magnetic body 205, so that the first magnetic body 204 and the basket top 208 are combined to form, with the second magnetic body 205, a magnetic loop for driving the first voice coil 210 to vibrate. The magnetization direction is a direction from the south pole to the north pole, namely, a direction from the S pole to the N pole. For example, the first side surface 217 of the first magnetic body 204 is the S pole, the second side surface 218 of the first magnetic body 204 is the N pole, an end that is of the second magnetic body 205 and that faces the first diaphragm 211 is the N pole, and an end that is of the second magnetic body 205 and that faces the second diaphragm 214 is the S pole.

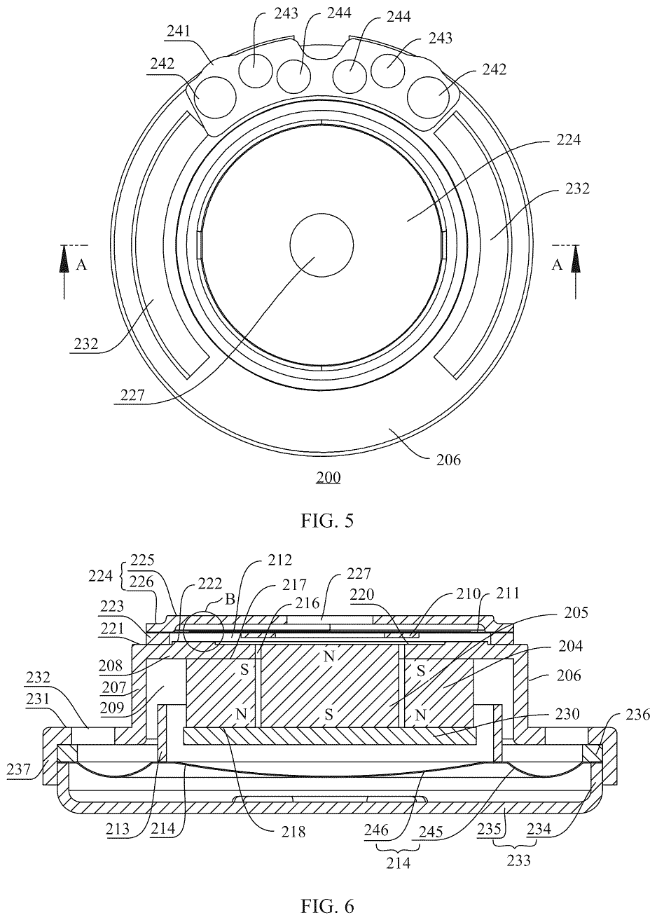

With reference to FIG. 2, FIG. 3, and FIG. 5, in some embodiments, the speaker 200 further includes a circuit board 241, the circuit board 241 is fastened to the basket 206, and the first voice coil 210 and the second voice coil 213 are separately electrically connected to the circuit board 241. Therefore, it is convenient to electrically connect the speaker 200 to another part in the headset 100 by using the circuit board 241, for example, electrically connect the speaker 200 to the battery. In this way, power can be supplied to the speaker 200. The circuit board 241 is further electrically connected to the mainboard of the headset 100. In an embodiment, the circuit board 241 is approximately arc-shaped, to be fastened to the radial extension part 231 of the basket 206. First connection positions 242, second connection positions 243, and third connection positions 244 are separately disposed in a direction from one end to the other end in a length direction of the circuit board 241. There are two first connection positions 242, there are two second connection positions 243, and there are two third connection positions 244. The two first connection positions 242 are symmetrically disposed, the two second connection positions 243 are symmetrically disposed, and the two third connection positions 244 are symmetrically disposed. The two first connection positions 242 are electrically connected to the mainboard, the two second connection positions 243 are electrically connected to the second voice coil 213, and the two third connection positions 244 are electrically connected to the first voice coil 210.

In the descriptions of the specification of this application, specific features, structures, materials, or characteristics may be properly combined in any one or more embodiments or examples.

Finally, it should be noted that the foregoing embodiments are only used to describe the technical solutions in this application, but are not used to limit this application. Although this application has been described in detail with reference to the foregoing embodiments, it should be understood by a person of ordinary skill in the art that the technical solutions described in the foregoing embodiments may still be modified, or some technical features thereof may be equivalently replaced. These modifications or replacements do not make the essence of the corresponding technical solutions depart from the spirit and scope of the technical solutions in the embodiments of this application.

1. A headset, comprising a speaker, wherein the speaker comprises a first magnetic body, a second magnetic body, a basket, a first voice coil, a first diaphragm, a second voice coil, and a second diaphragm;
wherein the first magnetic body is disposed around an outer circumference of the second magnetic body, and there is a gap between the first magnetic body and the second magnetic body;
wherein the basket comprises a peripheral part and a basket top connected to the peripheral part, the peripheral part is disposed around an outer circumference of the first magnetic body, and there is a first magnetic gap between the peripheral part and the first magnetic body;
wherein the first diaphragm and the second diaphragm are separately located on two opposite sides of the basket top;
wherein the first voice coil is connected to the first diaphragm, there is a preset gap between the first diaphragm and the basket top, the first voice coil is located in the preset gap, the first magnetic body and the basket top are combined to form a magnetic loop with the second magnetic body, and the first voice coil, the first magnetic body, the second magnetic body, and the basket top are fitted to drive the first diaphragm to vibrate; and
wherein the second voice coil is connected to the second diaphragm, a partial structure of the second voice coil extends into the first magnetic gap, a magnetic loop is formed between the first magnetic body and the peripheral part, and the second voice coil, the first magnetic body, and the peripheral part are fitted to drive the second diaphragm to vibrate.

2. The headset according to claim 1, wherein the basket top has a first through hole, a partial structure of the second magnetic body extends into the first through hole, and there is a gap between the first through hole and the partial structure that is of the second magnetic body and that extends into the first through hole.

3. The headset according to claim 1, wherein the first magnetic body is of a ring structure, the first magnetic body has a first side surface and a second side surface that are opposite to each other, and the basket top is in contact with the first side surface.

4. The headset according to claim 3, wherein a height direction of the first magnetic body is parallel to a direction from the first side surface to the second side surface, and in the height direction of the first magnetic body, a height of the first magnetic body is not greater than a height of the second magnetic body.

5. The headset according to claim 3, wherein the basket top totally covers the first side surface.

6. The headset according to claim 1, wherein the speaker further comprises a film, the first voice coil is fastened to one side surface of the first diaphragm, and the film is fastened to the other opposite side surface of the first diaphragm.

7. The headset according to claim 1, wherein a side that is of the basket top and that faces the first diaphragm has a first recessed groove, and at least a partial structure of the first voice coil is capable of extending into the first recessed groove.

8. The headset according to claim 7, wherein the side that is of the basket top and that faces the first diaphragm has a recessed structure, the recessed structure is distributed around a circumference of the first recessed groove, and a first protrusion part is formed between the recessed structure and the first recessed groove; and a circumferential edge of the first diaphragm is connected to a surface of the recessed structure.

9. The headset according to claim 8, wherein the speaker further comprises a first fastening ring, and the circumferential edge of the first diaphragm is connected to the surface of the recessed structure by using the first fastening ring.

10. The headset according to claim 9, wherein the speaker further comprises a first protective cover, and the circumferential edge of the first diaphragm is sandwiched between the first protective cover and the first fastening ring.

11. The headset according to claim 10, wherein a first sound output hole is disposed on the first protective cover.

12. The headset according to claim 11, wherein a damping fabric mesh is mounted on the first sound output hole.

13. The headset according to claim 1, wherein the speaker further comprises a first spring washer, the first magnetic body is located between the basket top and the first spring washer, and the first spring washer, the second voice coil, the first magnetic body, and the peripheral part are fitted to drive the second diaphragm to vibrate.

14. The headset according to claim 1, wherein the basket further comprises a radial extension part, the peripheral part is cylindrical, the basket top is connected to one end of the peripheral part, the radial extension part is connected to the other opposite end of the peripheral part, and a second sound output hole is disposed on the radial extension part.

15. The headset according to claim 14, wherein the speaker further comprises a second protective cover, the second protective cover is connected to the basket, and a circumferential edge of the second diaphragm is sandwiched between the radial extension part and the second protective cover.

16. The headset according to claim 15, wherein the speaker further comprises a second fastening ring, the second fastening ring is connected to the circumferential edge of the second diaphragm, and the circumferential edge of the second diaphragm is sandwiched between the second fastening ring and the second protective cover.

17. The headset according to claim 16, wherein the basket further comprises an axial extension part, the axial extension part is connected to the radial extension part, the axial extension part is in a ring shape, the second protective cover is inserted into the axial extension part, and the second fastening ring is located between the second protective cover and the radial extension part.

18. The headset according to claim 15, wherein a leakage hole is disposed on the second protective cover.

19. The headset according to claim 18, wherein a damping mesh fabric is disposed on the second sound output hole, and/or a damping mesh fabric is disposed on the leakage hole.

20.-26. (canceled)

27. A speaker, comprising:
a first magnetic body;
a second magnetic body;
a basket;
a first voice coil;
a first diaphragm;
a second voice coil; and
a second diaphragm;
wherein the first magnetic body is disposed around an outer circumference of the second magnetic body, and there is a gap between the first magnetic body and the second magnetic body;
wherein the basket comprises a peripheral part and a basket top connected to the peripheral part, the peripheral part is disposed around an outer circumference of the first magnetic body, and there is a first magnetic gap between the peripheral part and the first magnetic body;
wherein the first diaphragm and the second diaphragm are separately located on two opposite sides of the basket top;
wherein the first voice coil is connected to the first diaphragm, there is a preset gap between the first diaphragm and the basket top, the first voice coil is located in the preset gap, the first magnetic body and the basket top are combined to form a magnetic loop with the second magnetic body, and the first voice coil, the first magnetic body, the second magnetic body, and the basket top are fitted to drive the first diaphragm to vibrate; and
wherein the second voice coil is connected to the second diaphragm, a partial structure of the second voice coil extends into the first magnetic gap, a magnetic loop is formed between the first magnetic body and the peripheral part, and the second voice coil, the first magnetic body, and the peripheral part are fitted to drive the second diaphragm to vibrate.
